(19) United States
(12) Patent Application Publication
(10) Pub. No.: US 2013/0271256 A1
(43) Pub. Date: Oct. 17, 2013

(54) DUST CORE, METHOD FOR MANUFACTURING THE SAME, AND COIL COMPONENT

(71) Applicants: Tomoyuki Ueno, Itami-shi (JP); Yoshiyuki Shimada, Itami-shi (JP)

(72) Inventors: Tomoyuki Ueno, Itami-shi (JP); Yoshiyuki Shimada, Itami-shi (JP)

(73) Assignees: SUMITOMO ELECTRIC SINTERED ALLOY, LTD., Takahashi-shi, Okayama (JP); SUMITOMO ELECTRIC INDUSTRIES, LTD., Osaka-shi, Osaka (JP)

(21) Appl. No.: 13/995,770

(22) PCT Filed: Jul. 6, 2012
(86) PCT No.: PCT/JP2012/067289

§ 371 Date: Jun. 19, 2013

(30) Foreign Application Priority Data
Jul. 22, 2011 (JP) 2011-160978

(51) Int. Cl. H01F 3/08; H01F 41/02

(52) U.S. Cl. CPC H01F 3/08; H01F 41/0206
USPC 336/221; 419/66; 335/297

(57) ABSTRACT

A method includes a step of compacting an insulation-coated pure iron powder or an iron-based alloy powder mainly containing iron using a die to obtain a dust core, a step of heat-treating the obtained dust core, and a step of post-machining at least one portion of the heat-treated dust core using a grinding wheel. In the post-machining step, grinding is performed in such a manner that the dust core and the grinding wheel are rotated, whereby isotropic machining marks are formed on a machined surface of the dust core.

### TECHNICAL FIELD

The present invention relates to dust cores, method for manufacturing the same, and coil components. The present invention particularly relates to a dust core which is obtained in such a manner that a pure iron powder coated with an insulator or an iron-based alloy powder mainly containing iron is compacted using a die, followed by post-machining; a method for manufacturing the same; and a coil component.

### BACKGROUND ART

In recent years, various dust cores formed by compacting a pure iron powder or an iron-based alloy powder (hereinafter both referred to as “metal powder”) mainly containing iron have been proposed for use as cores for electromagnetic motors, fuel injection valves for diesel engines, ignition coils for gasoline engines, high-voltage reactors for electrified vehicles, or choke coils because the dust cores have more excellent high-frequency properties as compared to conventional electrical steel sheets and relatively higher flux density as compared to ferrite cores.

For example, PTL 1 discloses a method for manufacturing a dust core in such a manner that a compact is obtained by compacting a particle mixture containing first particles which include first metal particles mainly containing Fe and first insulating coated films formed thereon and which have a saturation flux density of 1.5 T or more and second particles which include second metal particles containing an element such as Al or Ni and second insulating coated films formed thereon and the compact is heat-treated at a temperature of 500° C. to 900° C.

In the manufacturing method disclosed in PTL 1, a desired shape is imparted to the dust core by die compacting. In the case where a complicated shape or high dimensional accuracy is required, it is difficult to form a desired shape only by compacting and therefore post-machining is necessary.

Therefore, it has been proposed that a dust core formed by compacting is post-machined such that a desired shape or desired accuracy is imparted to the dust core.

PTL 2 discloses a method for machining a dust core prepared from a soft magnetic material. The literature describes that the dust core is cut with a tool in which the radius of curvature of the cutting edge line is 1 μm or less in a cross section perpendicular to the rake face and the rake angle α satisfies the relation −10°≦α≦0°.

### CITATION LIST

### Patent Literature

PTL 1: Japanese Unexamined Patent Application Publication No. 2005-303006
PTL 2: Japanese Unexamined Patent Application Publication No. 2005-238357

### SUMMARY OF INVENTION

### Technical Problem

According to the machining method disclosed in PTL 2, a complicated shape can be imparted to the dust core by post-machining the dust core after compacting. Post-machining is cutting using a blade (turning tool) and therefore has a problem that tool life is short because the wear of a cutting edge is rapid. From the viewpoint of suppressing chipping, those used for cutting are limited to materials with a high density of more than 7.5 g/cm³ in some cases. Thus, in view of increases in manufacturing costs due to the frequent change of cutting edges and applicability to products with a density of less than 7.5 g/cm³, application to mass-produced products is difficult and there is a problem in versatility.

The present invention has been made in view of the foregoing circumstances and is intended to provide a dust core capable of reducing mass production costs, a method for manufacturing the same, and a coil component.

### Solution to Problem

(1) A method (hereinafter also simply referred to as “manufacturing method”) for manufacturing a dust core according to the present invention is characterized in that the manufacturing method includes a step of compacting an insulation-coated pure iron powder or an iron-based alloy powder mainly containing iron using a die to obtain the dust core, a step of heat-treating the obtained dust core, and a step of post-machining at least one portion of the heat-treated dust core using a grinding wheel. In the post-machining step, grinding is performed in such a manner that the dust core and the grinding wheel are rotated, whereby isotropic machining marks are formed on a machined surface of the dust core.

In the manufacturing method according to the present invention, the dust core is post-machined by grinding using the grinding wheel instead of cutting using a conventional blade; hence, the life of tools can be enhanced and therefore mass production costs for dust cores can be significantly reduced. Since grinding is performed in such a manner that the dust core, which is a workpiece, and the grinding wheel are both rotated, isotropic machining marks (tool marks) such as axisymmetric, concentric, or radial marks can be left on the machined surface (ground surface) by grinding. That is, unlike unidirectional machining marks (anisotropic machining marks) formed by conventional surface grinding, in which a curved surface of a rotating grindstone is pressed against a workpiece, the isotropic machining marks can be formed; hence, magnetic anisotropy is not induced in the machined surface of the dust core. As a result, magnetic properties of products can be enhanced.

(2) In the manufacturing method specified in Item (1), the die may include a first die and second die facing each other, at least one of the first die and the second die may exhibit a stepped shape having a convex portion and/or a concave portion or a shape that a plurality of stepped portions are separated, and the dust core obtained by compacting may have a density of 7.0 g/cm³ to 7.6 g/cm³. In this case, the dust core is lower in density than conventional dust cores (a density of about 7.7 cm³) and therefore mass producibility during compacting can be increased. Since the dust core has a low density of 7.0 g/cm³ to 7.6 g/cm³, the dust core has low strength and therefore there is a problem in that it is generally difficult to machine the dust core. If the dust core is ground by a conventional technique, the machined surface is torn or an edge portion is chipped; hence, one sufficient in quality cannot be obtained. Low-density dust cores have a large number of micropores remaining therein and therefore always keep cutting tools in an intermittent cutting state, leading to a significant reduction in tool life. This causes an increase in cost and therefore is not practical. However, in the present invention, since grinding is performed in such a manner that the dust core and the grinding wheel are both rotated, the machined surface is not torn, chipped, or damaged and therefore a high-quality product can be obtained. Furthermore, the life of tools can be enhanced and therefore mass production costs for dust cores can be significantly reduced. Thus, a manufacturing method according to the present invention is effective for a dust core which has a low density of 7.0 g/cm³ to 7.5 g/cm³ and a stepped shape and which needs to be post-machined because of such a complicated shape.

(3) In the manufacturing method specified in Item (1) or (2), the rotational speed of the dust core may range from 150 rpm to 1,500 rpm and the grinding wheel may be rotated at a peripheral speed of 720 m/min or more and not more than the maximum allowable peripheral speed thereof.

(4) In the manufacturing method specified in Items (1) to (3), the grinding wheel may contain abrasive grains which have a median diameter of 25 μm to 88 μm and which are made of diamond or cubic boron nitride.

(5) In the manufacturing method specified in Items (1) to (4), the grinding wheel may have a grinding surface which contributes to machining and which has at least one grooved portion extending to the outer edge of the grinding wheel and the width of the grooved portion may range from 0.05% to 1.00% of the effective outermost circumference of the grinding wheel. In this case, grinding swarf generated during grinding can be readily discharged outside by forming the grooved portion and the machined surface of the dust core can be prevented from being chipped or damaged due to the grinding swarf. A reduction in grinding function due to the loading of a grinding surface of a grindstone can be prevented.

(6) The manufacturing method specified in Items (1) to (5) may further include a step of dressing the grinding wheel. A major component of a dresser used for dressing may be at least one selected from the group consisting of white alumina, green silicon carbide, diamond, and cubic boron nitride. The dresser may have a median diameter of 18 μm to 105 μm.

(7) In the manufacturing method specified in Items (1) to (6), in the post-machining step, a water-soluble grinding solution containing 0.3% to 1.5% by mass of at least one of diethanolamine and triethanolamine may be used. In this case, a rust-proof effect can be imparted to the dust core without, for example, specific rust-proofing such as oiling after the dust core, which is iron-based, is machined. This enables the simplification of steps.

(8) In the manufacturing method specified in Items (1) to (7), the pure iron powder or the iron-based alloy powder mainly containing iron may have a median diameter of 60 μm to 250 μm.

(9) In the manufacturing method specified in Items (1) to (8), the pure iron powder or the iron-based alloy powder mainly containing iron may be compacted at a contact pressure of 6 ton/cm² to 13 ton/cm².

(10) In the manufacturing method specified in Items (1) to (9), in the heat-treating step, the dust core may be heat-treated at a temperature of 300° C. to 600° C. for at least ten minutes in air, a nitrogen atmosphere, or a flow of a mixture thereof.

(11) The manufacturing method specified in Items (1) to (10) may further include a step of removing burrs formed on the surface of the dust core during compacting or post-machining. The burrs may be removed using a brush prepared from a synthetic resin combined with hard abrasive grains made of white alumina or green silicon carbide.

(12) The manufacturing method specified in Item (11) may further include a step of performing degaussing subsequently to the removal of the burrs such that the remanence is 5 mT or less.

(13) The manufacturing method specified in Item (12) may further include a step of washing the dust core with a washing liquid containing the water-soluble grinding solution used during post-machining at a discharge pressure of 0.05 MPa to 0.40 MPa subsequently to degaussing.

(14) A dust core according to the present invention is characterized in that the dust core is formed by compacting an insulation-coated pure iron powder or an iron-based alloy powder mainly containing iron using a die. The dust core has a machined surface having isotropic machining marks formed on at least one portion thereof by a grinding wheel, exhibits a stepped shape having a convex portion or a concave portion or a shape that a plurality of stepped portions are separated, and has a density of 7.0 g/cm³ to 7.6 g/cm³.

In the dust core according to the present invention, the machined surface (ground surface) has isotropic machining marks (tool marks) such as axisymmetric, concentric, or radial marks and therefore magnetic anisotropy is not induced in the machined surface of the dust core.

As a result, magnetic properties of products can be enhanced.

(15) In the dust core specified in Item (14), the dimensional accuracy of the flatness and parallelism of the machined surface may be 50 μm or less in terms of machining error.

(16) The dust core specified in Item (14) or (15) may include at least one portion coated with a rust-proof layer containing at least one of diethanolamine and triethanolamine which is a component of a water-soluble grinding solution used during machining due to a grinding wheel.

(17) A coil component according to the present invention is characterized in that the coil component is prepared by coiling a copper wire around a dust core manufactured by a manufacturing method specified in Items (1) to (13).

### Advantageous Effect of Invention

According to a dust core, method for manufacturing the same, and coil component according to the present invention, mass production costs can be reduced.

### BRIEF DESCRIPTION OF DRAWINGS

FIG. 1 is a flowchart illustrating a manufacturing method according to an embodiment of the present invention.

FIG. 2(a) is a perspective view illustrating a dust core according to an embodiment of the present invention.

FIG. 2(b) is a sectional view illustrating a dust core according to an embodiment of the present invention.

FIG. 3 is a sectional view illustrating an example of a stepped die.

FIG. 4 is a sectional view illustrating an example of a separable die.

FIG. 5(a) is a sectional view illustrating a grindstone used in a manufacturing method according to the present invention.

FIG. 5(b) is a bottom view illustrating the grindstone used in the manufacturing method according to the present invention.

FIG. 6 is a plan view illustrating the grindstone shown in FIGS. 5(a) and 5(b).

FIG. 7(a) is an illustration showing the relationship between the position of a dust core and the position of a grindstone.

FIG. 7(b) is an illustration showing the relationship between the position of a dust core and the position of a grindstone.

FIG. 8 is an illustration of an experiment apparatus used to measure magnetic attractive force.

FIG. 9 is an illustration of an armature used in an experiment.

FIG. 10 is a graph showing experiment results.

FIG. 11 is an illustration showing a machined surface of a dust core according to Example 1.

FIG. 12 is an illustration showing a machined surface of a dust core according to Example 2.

FIG. 13 is an illustration showing a machined surface of a dust core according to Comparative Example 1.

### DESCRIPTION OF EMBODIMENTS

Embodiments of a dust core, a method for manufacturing the same, and a coil component according to the present invention will now be described in detail with reference to the accompanying drawings.

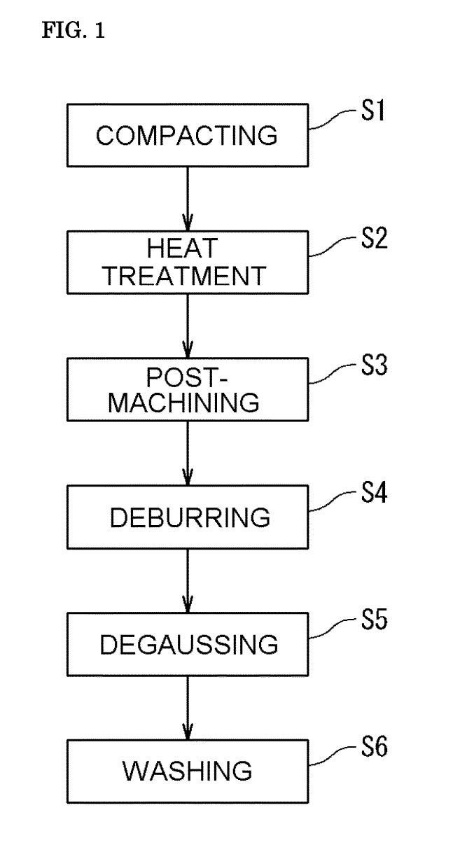

FIG. 1 is a flowchart illustrating a manufacturing method according to an embodiment of the present invention. A method for manufacturing a dust core according to the present invention is described below in accordance with the flowchart.

### [Compacting]

In the manufacturing method according to the present invention, in Step S1, a metal powder of raw material is compacted using a die. In this step, from the viewpoint of increasing the compactibility, an appropriate amount of a lubricant may be mixed.

In the present invention, the metal powder of raw material is not particularly limited and one conventionally used to manufacture dust cores can be appropriately used. For example, a pure iron powder or an iron-based alloy powder containing iron as a base material and nickel or cobalt added thereto can be used. In particular, Fe, Fe—Si, Fe—Co, Fe—Ni, Fe—Ni—Co, Fe—Si—B, or the like can be used.

In the present invention, the particle size of the metal powder is not particularly limited and one having a median diameter or D50 particle size (in the histogram of the particle size determined by a sieve method, the size of particles where the sum of the masses of the smaller particles accounts for 50% of the total mass) of 60 μm to 250 μm can be used. Particles less than 60 μm are poor in powder fluidity and therefore have a problem with poor compactibility. In contrast, particles larger than 250 μm have a problem that the loss of eddy currents generated in these particles is excessively large and therefore have a problem that the electromagnetic transduction efficiency is significantly low.

Metal particles are coated with insulating films (insulator). The insulating films function as insulating layers between the metal particles. The electric resistivity ρ of the dust core can be increased by coating the metal particles with the insulating films. This controls eddy currents to flow between the metal particles and allows the iron loss due to the eddy currents to be reduced.

The insulating films can be formed by coating the metal particles with, for example, a phosphate and preferably contain an oxide. When the insulating films contain the oxide, the following material can be used to form the insulating films: iron phosphate, which contains phosphorus and iron, manganese phosphate, zinc phosphate, calcium phosphate, aluminium phosphate, or an oxide insulator such as silicon oxide, titanium oxide, aluminium oxide, or magnesium oxide. The insulating films may have a single-layer structure or a multilayer structure.

The thickness of each insulating film is not particularly limited and is usually about 10 nm to 100 nm. When the thickness is less than 10 nm, the insulating film is likely to be broken and the metal particles are brought into direct contact with each other with high frequency. When the thickness is more than 100 nm, a reduction in magnetic permeability arises.

The metal powder, which is coated with the insulator, is supplied into a die and is compacted with a contact pressure of, for example, 6 ton/cm² to 13 ton/cm². When the contact pressure is less than 6 ton/cm², the compaction density of the dust core is extremely low and therefore there is a problem in that desired strength cannot be achieved. In contrast, when the contact pressure is more than 13 ton/cm², the load applied to a press or the die is large and therefore there is a problem with increases in manufacturing costs. In this step, the die or the powder need not be heated (cold pressing) and may be heated to 50° C. to 150° C. (warm pressing) from the viewpoint of increasing the lubricity of a lubricant appropriately mixed.

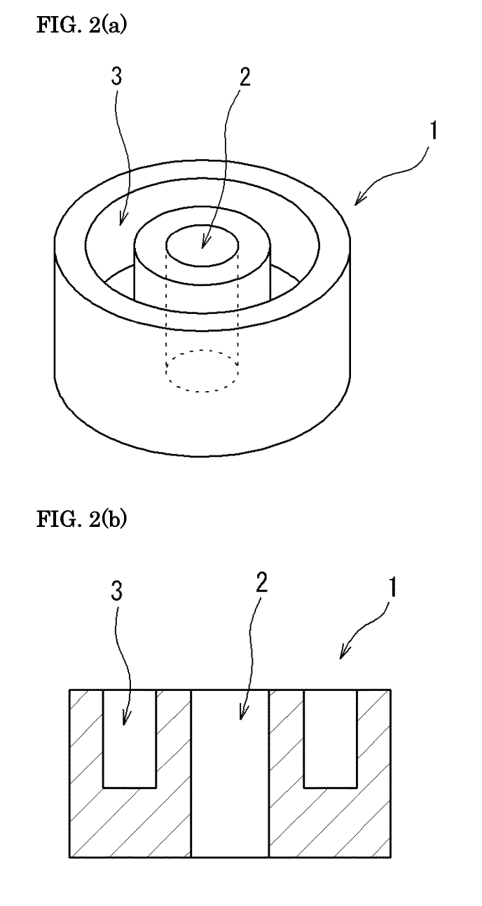

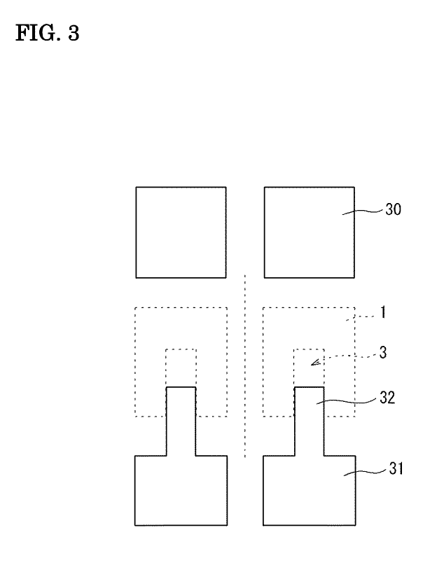

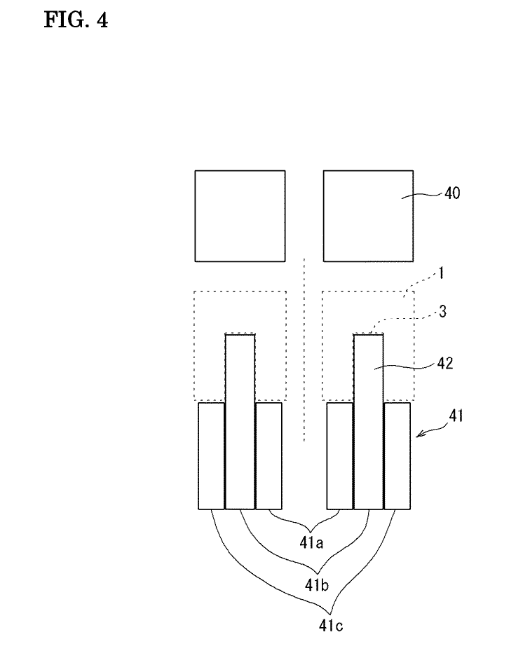

The dust core 1, which is obtained by compacting, does not have a simple shape like a simple rectangular parallelepiped or short cylinder but has a complicated shape and is a short cylinder having a centered through-hole 2 and a ring-shaped recess 3 formed in a surface thereof as shown in FIGS. 2(a) and 2(b). The dust core 1 is prepared from a pair of dies (a first die and a second die) facing each other. As shown in FIG. 3, at least one of the dies has a stepped shape including a protrusion corresponding to the recess 3 as shown in FIG. 3 or consists of a plurality of (three) separate parts corresponding to the recess 3 as shown in FIG. 4. In particular, the step-shaped die shown in FIG. 3 is composed of an upper punch (first die) 30 and a lower punch (second die) 31. The upper punch 30 and the lower punch 31 are both axisymmetric and are a single piece.

The lower die 31 includes a convex portion 32 corresponding to the recess 3 of the dust core 1. The separate type of die shown in FIG. 4 is composed of an upper punch (first die) 40 and a lower punch (second die) 41. The upper punch 40 is axisymmetric and is a single piece. The lower punch 41 is composed of three separate dies 41a, 41b, and 41c which are axisymmetric. The three separate dies 41a, 41b, and 41c are axisymmetric. The separate die 41b of the lower punch 41 includes a convex portion 42 corresponding to the recess 3 of the dust core 1. For the separate type of die shown in FIG. 4, the number of separate parts may be, for example, two like a mode in which the separate die 41a and the separate die 41b are combined into one.

The size of the dust core 1, which is shown in FIG. 2(a), varies depending on use. The dust core 1 has, for example, a diameter of 20 mm and a height of 12 mm.

The density (green density) of the dust core 1 is lower than that of conventional products. The density thereof is usually 7.0 g/cm³ to 7.6 g/cm³, preferably 7.2 g/cm³ to 7.5 g/cm³, and more preferably 7.25 g/cm³ to 7.45 g/cm³. The contact pressure or the like is adjusted such that the density thereof is within the above range. When the green density ranges from 7.0 g/cm³ to 7.6 g/cm³, the mass producibility of the dust core can be significantly increased in association with the use of grinding as post-machining and a high throughput of, for example, 300 pieces/hr or more, 600 pieces/hr or more, or 900 pieces/hr or more can be achieved.

### [Heat Treatment]

The dust core 1 formed by compacting in Step S1 is subsequently heat-treated in Step S2. In the heat treatment, the residual stress induced during the degreasing of the lubricant used for compacting or during compacting is eliminated and the effect of increasing material strength can be expected. The heat treatment is performed in such a manner that the dust core 1 is calcined at a temperature of 300° C. to 600° C. for at least ten minutes in air or a nitrogen atmosphere. When the calcination temperature is lower than 300° C., the lubricant, which has been mixed with the metal powder before compacting, may possibly remain in the dust core and therefore the strength of the dust core may possibly be reduced. In contrast, when the calcination temperature is higher than 600° C., the insulating films, which cover the metal powder, are thermally decomposed and therefore dielectric breakdown may possibly be caused. The calcination temperature preferably ranges from 400° C. to 550° C. The calcination time is preferably about 20 minutes to 60 minutes.

### [Post-Machining]

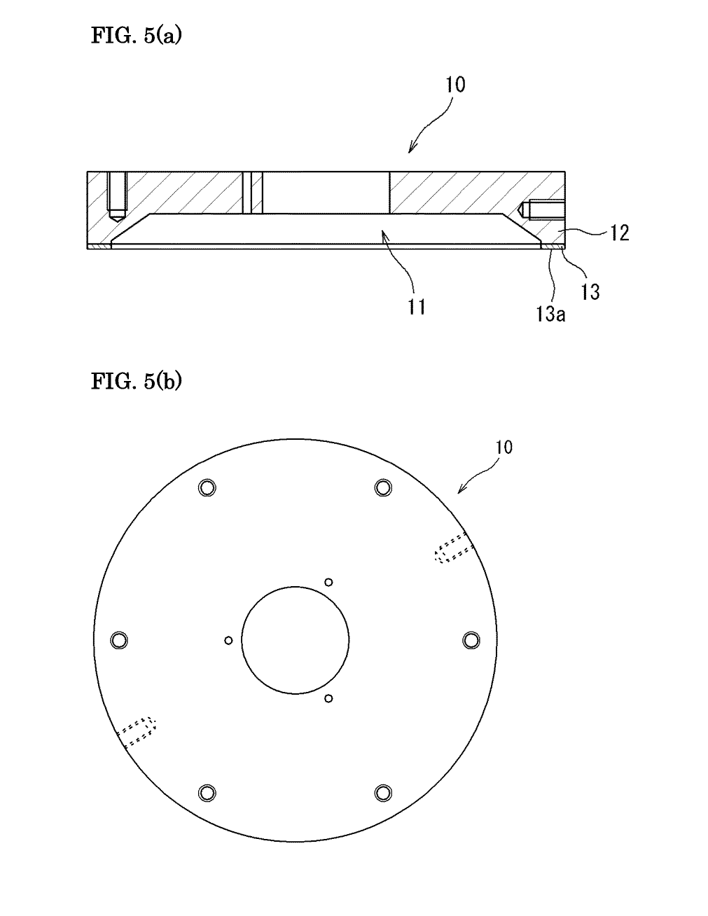

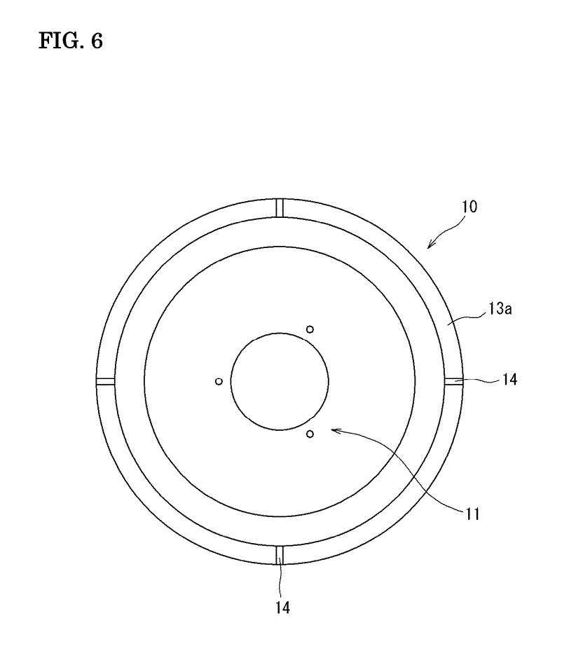

The dust core 1 heat-treated in Step S2 is subsequently post-machined in Step S3. In this embodiment, post-machining is performed using a grinding wheel 10 shown in FIGS. 5(a) to 6. The grinding wheel 10 is cup-shaped, has a recess 11 formed in a surface thereof, and includes a grindstone portion 13 located at the periphery 12 of the surface having the recess 11. The grindstone portion 13 contains abrasive grains and a bonding agent bonding the abrasive grains. The abrasive grains used are preferably, for example, diamond particles or cubic boron nitride (cBN) particles in view of high strength and the fact that the morphology of grindstones is unlikely to be disrupted. The abrasive grains used may be those prepared by adding fine diamond particles, fine cBN particles, a slight amount of WA (white alumina), and/or a slight amount of GC (green silicon carbide) to the diamond particles or the cubic boron nitride (cBN) particles in the hope of obtaining the strengthening effect of the bonding agent.

In the present invention, the size of the abrasive grains, which are contained in the grindstone portion 13, is not particularly limited and the abrasive grains preferably have a median diameter of 25 μm to 88 μm, more preferably 30 μm to 62 μm, and further more preferably 44 μm to 53 μm. The grit size of grindstones can be defined as the size of abrasive grains. The grit size #170-200 corresponds to a median diameter of 88 μm, the grit size #200-230 corresponds to a median diameter of 74 μm, the grit size #230-270 corresponds to a median diameter of 62 μm, the grit size #270-325 corresponds to a median diameter of 53 μm, the grit size #325-400 corresponds to a median diameter of 44 μm, the grit size #500 corresponds to a median diameter of 30 μm to 36 μm, and the grit size #600 corresponds to a median diameter of 25 μm to 35 μm. Thus, a median diameter of 25 μm to 62 μm corresponds to the grit size #270-600.

When the median diameter is less than 25 μm, a grindstone is likely to be loaded and therefore needs to be frequently dressed (dress). This is not practical for mass production because the time taken for machining needs to be secured by reducing the time taken for dressing or the feed rate. In contrast, when the median diameter is more than 88 μm, there is a problem in that the roughness of a machined surface is large and therefore good quality cannot be achieved.

As shown in FIG. 6, a grinding surface 13a of the grindstone portion 13 has grooved portions 14 extending to the outer edge of the grindstone portion 13, which is ring-shaped. In this embodiment, the number of the grooved portions 14 is four and the grooved portions 14 are arranged at equal circumferential intervals. The formation of the grooved portions 14 allows grinding swarf generated during grinding to be readily discharged outside; hence, a machined surface of the dust core can be prevented from being chipped or damaged due to the grinding swarf. Furthermore, the grinding function of the grinding surface 13a of the grindstone portion 13 can be prevented from being reduced due to loading. The width of the grooved portions 13 can be selected in consideration of the grinding function therefore or the function of discharging the grinding swarf and may range from, for example, 0.05% to 1.00% of the effective outermost circumference of the grindstone portion 13 of the grinding wheel 10.

For example, in the case where, the grooved portions, which have a width of 3 mm are formed in the grinding wheel, which has a diameter φ of 305 mm, the grooved portions account for about 0.3% of the effective outermost circumference of the grindstone portion 13.

In the present invention, grinding using the grinding wheel is used as the post-machining of the dust core instead of grinding using a blade. In order to prevent magnetic properties from being reduced due to magnetic anisotropy induced in a machined surface, grinding is performed in such a manner that the dust core, which is a workpiece, and the grinding wheel are both rotated.

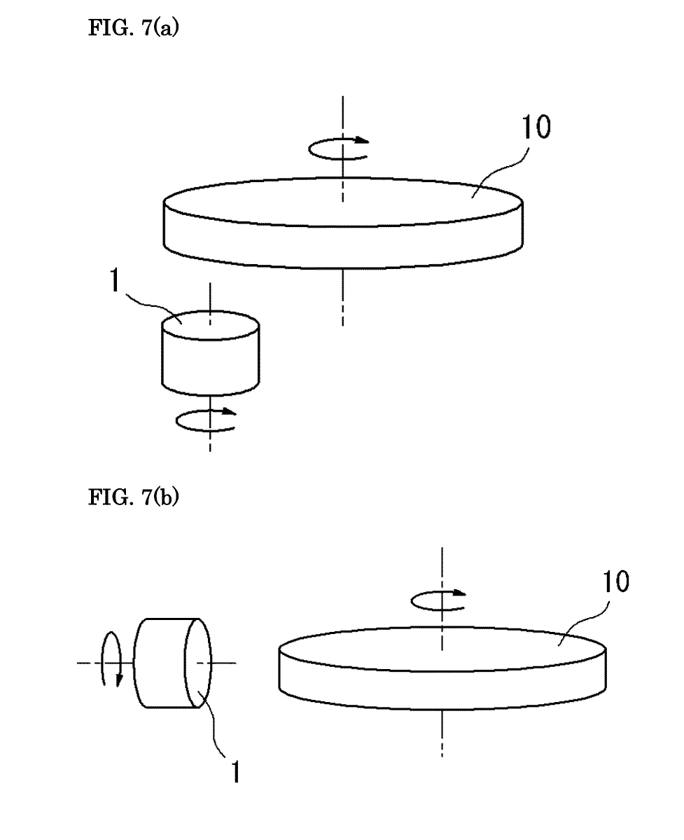

FIGS. 7(a) and 7(b) are illustrations showing the relationship between the position of the dust core and the position of the grinding wheel during grinding. When the dust core has a short cylinder shape and the grinding wheel has a disk shape, there are various possible models for the relationship therebetween depending on where the machined surface of the dust core and a grinding surface of the grinding wheel are set. Examples of the models include the case where a flat surface of the dust core is ground with a flat surface of the grinding wheel, the case where a die end surface is surface-ground (FIG. 7(a)), and the case where a flat surface of the dust core is ground with a curved surface of the grinding wheel (FIG. 7(b). In every case, grinding is performed in such a manner that the dust core and the grinding wheel are both rotated. With reference to FIG. 7(a), the axis of rotation of the dust core and that of the grinding wheel are parallel to each other. With reference to FIG. 7(b), the axis of rotation of the dust core and that of the grinding wheel are perpendicular to each other. In the case shown in FIG. 7(a), the rotating grinding wheel is moved downward to touch a flat surface of the dust core ground and the flat surface thereof is ground. In FIGS. 7(a) and 7(b), a rotational direction indicated by an arrow is for exemplification only. For example, in the case shown in FIG. 7(a), the axis of rotation of the dust core and that of the grinding wheel may be opposite to each other.

Since grinding is performed in such a manner that the dust core, which is a workpiece, and the grinding wheel are both rotated, isotropic machining marks (tool marks) such as axisymmetric, concentric, or radial marks can be left on a machined surface (ground surface). That is, unlike unidirectional machining marks (anisotropic machining marks) formed by conventional surface grinding, in which a curved surface of a rotating grindstone is pressed against a workpiece, the isotropic machining marks can be formed; hence, magnetic anisotropy is not induced in the machined surface of the dust core. As a result, magnetic properties of products can be enhanced.

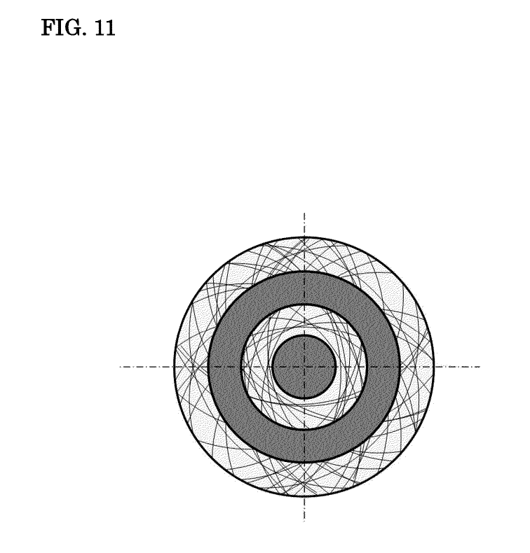

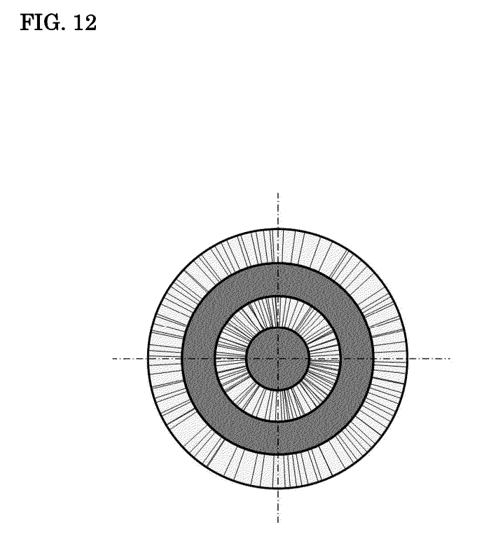

When the diameter of the grinding wheel is sufficiently larger than the dust core, substantially linear machining marks are isotropically engraved in the machined surface of the dust core (refer to FIG. 12 below). When the diameter of the grinding wheel is not much larger than the dust core, arc machining marks are isotropically engraved in the machined surface of the dust core (refer to FIG. 11 below). As long as machining marks are isotropically engraved, any of these cases acceptable.

The rotational speed of the dust core 1 is not particularly limited and may range from about 150 rpm to 1,500 rpm. When the rotational speed is lower than 150 rpm, machining load is increased and the machined surface is chipped or is torn. In contrast, when the rotational speed is high, machining load is decreased and there is an advantage that the life of the grinding wheel is increased and properties of the machined surface are enhanced. When the rotational speed is higher than 1,500 rpm, vibration or chattering occurs and therefore machining accuracy may possibly be reduced.

The speed of the grinding surface of the grinding wheel 10 varies depending on the diameter thereof and therefore definition by peripheral speed is more correct. In the present invention, the peripheral speed of the grinding wheel 10 is not particularly limited and may be about 720 m/min to the maximum allowable peripheral speed thereof. When the peripheral speed is lower than 720 m/min, grinding efficiency is reduced and there is a problem in that machining time is long.

In general, geometric accuracy including the size, flatness, parallelism, circularity, cylindricity, and surface roughness of the machined surface with respect to a reference plane can be cited as the dimensional accuracy of a machined surface. In this embodiment, the flatness and parallelism of the machined surface are preferably 50 μm or less, more preferably 25 μm or less, and further more preferably 3 μm or less.

Upon grinding, a grinding solution is supplied to the grinding surface. The grinding solution is an oil-based one or an emulsion type. In this embodiment, the grinding solution used is water-soluble and contains a rust-proof component. The use of the grinding solution allows a rust-proof effect to be imparted to the dust core without, for example, specific rust-proofing such as oiling after the dust core, which is iron-based, is machined. This enables the simplification of steps.

The rust-proof component used may be a water-soluble one which has no toxicity or side-effect and which is usually used. For example, diethanolamine and triethanolamine can be used. The concentration of diethanolamine and/or triethanolamine contained in the grinding solution is usually about 0.3% to 1.5% by mass. One or both of diethanolamine and triethanolamine may be contained therein. The content of diethanolamine and triethanolamine in a commercially available undiluted solution is about 15% to 50% by mass and therefore a desired concentration is obtained by 30 to 50 times diluting the undiluted solution.

In the case where the grinding solution, which contains the rust-proof component such as diethanolamine or triethanolamine and is water-soluble, is used and the dust core is washed with a washing liquid containing the grinding solution in a washing step below, a rust-proof layer containing the rust-proof component can be formed on at least one portion of the dust core. The rust-proof layer allows the corrosion resistance of the dust core to be increased.

The grinding wheel, which is used for grinding, needs to be periodically dressed because the grinding wheel is loaded and the abrasive grains are gradually worn or removed with continuous use. As a major component of a dresser used for such dressing, white alumina which has the same grit size as that of the abrasive grains or which is one grade coarser than the abrasive grains is generally used. The present invention is not limited to this and other materials such as green silicon carbide, diamond, and cubic boron nitride can be used herein. The major component of the dresser may be single or a mixture of two or more types of substance. The particle size of the dresser need not be the same as the grit size of the abrasive grains and those that are one grade finer or one grade coarser than the abrasive grains can be used. The particle size of the dresser may range from, for example, about 18 μm to 105 μm. When the particle size thereof is less than 18 μm, sufficient dressing performance cannot be achieved. In contrast, when the particle size thereof is more than 105 μm, a grinding surface of the grindstone that contributes to machining may possibly be coarsened.

The interval of dressing (dressing interval) varies depending on materials for the dust core and the abrasive grains or the time taken to grind a single dust core. Minor dressing (temporary dressing) can be performed after about 150 or more (for example, 300 to 500) dust cores are machined subsequently to previous dressing. Major dressing (regular dressing) can be performed after about 900 or more (for example, 1,500) dust cores are machined subsequently to previous dressing.

A single grinding wheel may be used to grind a single dust core or a plurality of (for example, two) dust cores.

### [Deburring]

The dust core 1 post-machined in Step S3 is subsequently deburred in Step S4. A compacted surface of the dust core has burrs (die burrs) corresponding to joints of die components and a ground surface thereof has burrs (machining burrs) caused by the sliding of the grinding wheel. In this embodiment, the burrs are removed using a brush prepared from a synthetic resin combined with hard abrasive grains. The hard abrasive grains used may be, for example, white alumina particles or green silicon carbide particles.

### [Degaussing]

The dust core 1 deburred in Step S4 is subsequently degaussed in Step S5. Degaussing can be performed in accordance with common practice. The dust core can be degaussed by applying, for example, an alternating-current magnetic field thereto. The dust core is preferably degaussed so as to have a remanence of 5 mT or less.

### [Washing]

The dust core 1 degaussed in Step S5 is subsequently washed in Step S6. In general, washing can be performed using clean water. In the case of using the water-soluble grinding solution, which contains the rust-proof component, during post-machining (grinding) in Step S3, the washing liquid, which contains the water-soluble grinding solution, is preferably used. In this case, the rust-proof component remains on the surface of the dust core and therefore a rust-proof effect can be imparted to the dust core without, for example, specific rust-proofing such as oiling. Washing can be performed in such a manner that the washing liquid is applied to the dust core at a discharge pressure of, for example, 0.05 MPa to 0.40 MPa, preferably 0.1 MPa to 0.40 MPa, and more preferably 0.20 MPa to 0.30 MPa. When the discharge pressure is less than 0.05 MPa, chippings or deburring swarf generated by machining or in the deburring step cannot be washed out. In contrast, when the discharge pressure is more than 0.40 MPa, a workpiece needs to be fixed and therefore steps are complicated. In usual, the washing liquid is applied to the dust core at a discharge pressure of about 0.25 MPa.

The washed dust core is dried at, for example, room temperature for about 30 minutes.

### EXAMPLES AND COMPARATIVE EXAMPLES

Examples of a dust core according to the present invention are described below. The present invention is not limited to the examples.

### Example 1

A pure iron powder, insulation-coated with a phosphate, having a median diameter of 95 μm was put into a die and was compacted using a press punch with a concave stepped die shape at a contact pressure of 8 ton/cm², whereby a dust core with a shape shown in FIG. 2(a) was prepared. The dust core had a green density of 7.30 g/cm³.

The obtained dust core was heat-treated at 500° C. for ten minutes in an air atmosphere.

Subsequently, a surface (in FIG. 2(a), the upper surface) of the dust core that had a recess was ground using a grinding wheel with a shape shown in FIG. 3 under conditions below.

Grinding Conditions

Abrasive grains of grinding wheel: diamond

Average size of abrasive grains: 44 μm

Outside diameter of grinding wheel: φ60 mm

Peripheral speed of grinding wheel: 1,800 m/min

Slit width of grindstone: 0.3% of effective outermost circumference

Abrasive grains of grindstone dresser: white alumina

Average particle size of grindstone dresser: 44 μm

Rotational speed of dust core: 250 rpm

Grinding method: die end surface surface-grinding (refer to FIG. 7(a))

Grinding time: five seconds

Grinding solution: water-soluble grinding solution containing 1.0% by mass of diethanolamine

In Example 1, three dust cores were prepared. FIG. 11 illustrates a ground surface of one of the dust cores.

### Example 2

A pure iron powder, insulation-coated with a phosphate, having a median diameter of 85 μm was put into a die and was compacted using a concave multi-stepped press punch at a contact pressure of 12 ton/cm², whereby a dust core with a shape shown in FIG. 2(a) was prepared. The dust core had a green density of 7.45 g/cm³.

The obtained dust core was heat-treated at 420° C. for 60 minutes in a nitrogen atmosphere.

Subsequently, a surface (in FIG. 2(a), the upper surface) of the dust core that had a recess was ground using a grinding wheel with a shape shown in FIGS. 5(a) and 5(b) under conditions below.

Grinding Conditions

Outside diameter of grinding wheel: φ305 mm

Abrasive grains of grinding wheel: cBN

Average size of abrasive grains: 53 μm

Peripheral speed of grinding wheel: 2,000 m/min

Slit width of grindstone: 0.3% of effective outermost circumference

Abrasive grains of grindstone dresser: white alumina

Average particle size of grindstone dresser: 53 μm

Rotational speed of dust core: 450 rpm

Grinding method: die end surface surface-grinding (refer to FIG. 7(a))

Grinding time: five seconds

Grinding solution: water-soluble grinding solution containing 1.0% by mass of diethanolamine

In Example 2, two dust cores were prepared. FIG. 12 illustrates a ground surface of one of the dust cores.

### Comparative Example 1

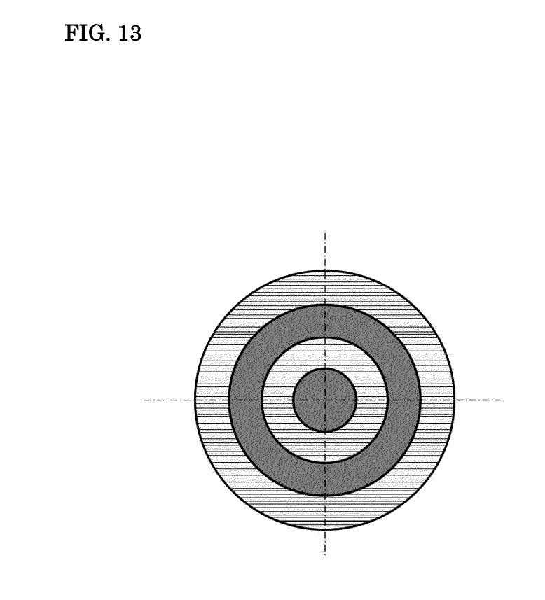

A dust core was prepared in substantially the same manner as that described in Example 1 except that the dust core was not rotated. FIG. 13 illustrates a ground surface of the dust core prepared in Comparative Example 1.

### For Ground Surface

In Comparative Example 1, since the dust core is ground in such a state that the dust core is not rotated but is fixed, the ground surface has anisotropic machining marks extending in substantially one direction as shown in FIG. 13. In Example 1 or 2, machining marks extend concentrically or radially as shown in FIG. 11 or 12, respectively, that is, axisymmetric isotropic machining marks are present. In Example 1, the diameter of the grinding wheel is not much less than each dust core and therefore arc machining marks are isotropically engraved in the ground surface of the dust core. In Example 2, the diameter of the grinding wheel is sufficiently less than each dust core and therefore substantially linear machining marks are isotropically engraved in the ground surface of the dust core.

### Measurement of Magnetic Attractive Force

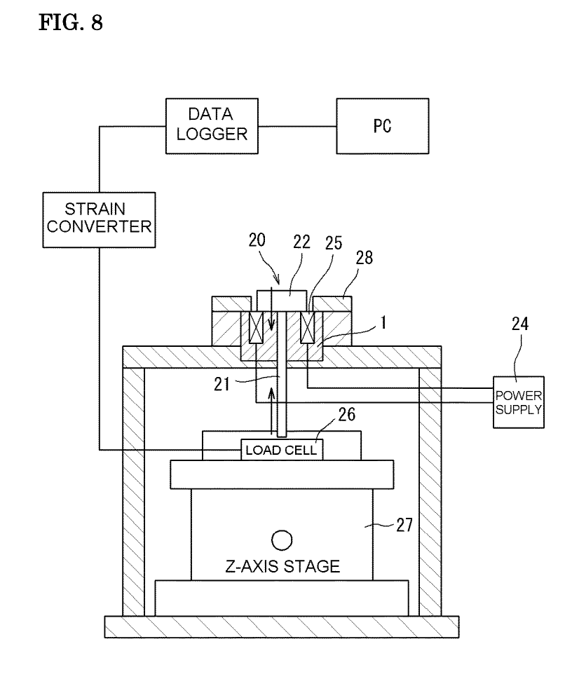

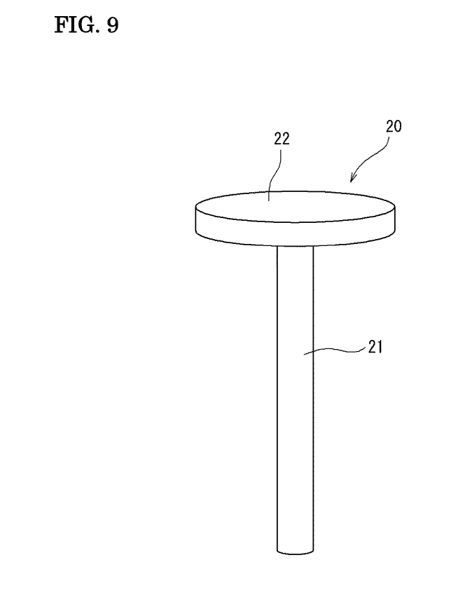

After each obtained dust core was deburred using the above-mentioned brush (Step S4), was degaussed (Step S5), and was then washed (Step S6), the ground surface thereof was evaluated for magnetic properties using an apparatus shown in FIG. 8. The obtained dust core 1 was used as a stator, a coil 25 (the number of turns of the coil being 36) was provided in the recess, and the coil 25 was connected to a power supply 24. A stem 21 of an armature 20 shown in FIG. 9 was inserted into a through-hole of the dust core 1 such that the back surface of a disk 22 abutted on the ground surface of the dust core 1. The disk 22 of the armature 20 was made of Fe—Si (a magnetic material) and the stem 21 thereof was made of stainless steel (a non-magnetic material). The upward movement of the dust core 1 was restricted by a retainer plate 28.

A load cell 26 was provided under an end surface of the stem 21 of the armature 20 so as to be slightly spaced from the end surface thereof. A Z-axis stage 27 overlaid with the load cell 26 was movable upward and downward.

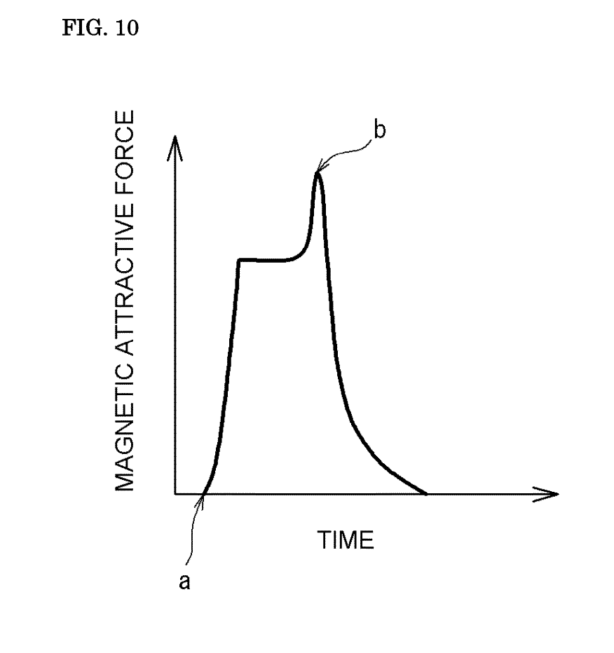

A current of 1 A was supplied from the power supply. The supply of such a current magnetized the dust core to generate a magnetic attractive force on the ground surface thereof. The disk 22, which was made of a magnetic material, of the armature 20 was stuck on the ground surface by the magnetic attractive force. In this state, the Z-axis stage 27 was gradually raised and the force applied to the load cell 26 was measured. The maximum force applied thereto when the disk 22 of the armature 20 was separated from the ground surface of the dust core was defined as the attractive force. The relationship between the time elapsed from the start of raising the load cell 26 and the magnetic attractive force is substantially as shown in FIG. 10. The measurement of the magnetic attractive force is started at Point a where the load cell 26 abuts on the end surface of the stem 21 of the armature 20 and a measurement thereof increases with the raise of the load cell 26, peaks at Point b where the disk 22 of the armature 20 is separated from the ground surface of the dust core, and then gradually decreases to zero.

This experiment was performed three times for each dust core and the average value was determined. The dust core was evaluated from the average value. Results are shown in Table 1.

TABLE 1

| | Measurement of | | | | |
|---|---|---|---|---|---|
| | attractive force (V) | | | | Evalu- |
| | Raw data | | | Ave. | ation |
| Example 1 | 3.385 | 3.225 | 3.985 | 3.5 | Good |
| (Isotropic machining) | 3.145 | 3.425 | 2.946 | 3.2 | Good |
| (Small-diameter grindstone) | 2.906 | 3.983 | 4.501 | 3.8 | Good |
| Example 2 | 3.783 | 3.185 | 3.584 | 3.5 | Good |
| (Isotropic machining) | 2.826 | 3.823 | 3.983 | 3.5 | Good |
| (Large-diameter grindstone) | | | | | |
| Comparative Example 1 | 3.151 | 2.593 | 2.792 | 2.8 | Poor |
| (Anisotropic machining) | | | | | |

The attractive force required in specifications is 3.0 V. Examples 1 and 2 meet this requirement. However, Comparative Example 1 cannot meet this requirement. This shows that magnetic properties of a ground surface can be enhanced by a manufacturing method according to the present invention in which grinding is performed in such a manner that a dust core and a grinding wheel are both rotated.

The index “3 V” for evaluation is based on the fact that as a result of calculating the flux density and magnetic permeability obtained by evaluating toroidal test pieces prepared under the same conditions as those described in Example 1, a value of 3 V or more is preferably obtained.

### Example 3

A dust core obtained in Example 1 was deburred using the above-mentioned brush (Step S4), was degaussed (Step S5), and was then washed with a washing liquid containing a grinding solution used during grinding (Step S6).

The obtained dust core did not rust without, for example, specific rust-proofing such as oiling after the dust core was left for one year in an air atmosphere, because a rust-proof component contained in the washing liquid remained on the surface of the dust core.

### Comparative Example 2

A dust core obtained in Example 1 was deburred using the above-mentioned brush (Step S4), was degaussed (Step S5), and was then washed with ordinary clean water free from a grinding solution used during grinding (Step S6).

The obtained dust core rusted as sufficiently identified by visual inspection after the dust core was left for two days in an air atmosphere, because a rust-proof component attached to the surface of the dust core was washed out with water.

### Example 4

A pure iron powder, insulation-coated with a phosphate, having a median diameter of 250 μm was put into a die and was compacted using a concave multi-stepped press punch at a contact pressure of 8 ton/cm², whereby a dust core with a shape shown in FIG. 2(a) was prepared. The dust core had a green density of 7.50 g/cm³.

The obtained dust core was heat-treated at 300° C. for 120 minutes in an air atmosphere.

Subsequently, a surface (in FIG. 2(a), the upper surface) of the dust core that had a recess was ground using a grinding wheel with a shape shown in FIGS. 5(a) and 5(b) under conditions below.

Grinding Conditions

Outside diameter of grinding wheel: φ305 mm

Abrasive grains of grinding wheel: cBN

Average size of abrasive grains: 88 μm

Peripheral speed of grinding wheel: 1,500 M/min

Abrasive grains of grindstone dresser: green silicon carbide

Average particle size of grindstone dresser: 105 μm

Rotational speed of dust core: 600 rpm

Grinding method: die end surface surface-grinding (refer to FIG. 7(a))

Grinding time: five seconds

Grinding solution: water-soluble grinding solution containing 0.3% by mass of diethanolamine

In Example 4, two dust cores were prepared. FIG. 12 illustrates a ground surface of one of the dust cores.

After being left for one year in a green silicon carbide atmosphere, the dust cores did not rust.

### Example 5

A pure iron powder, insulation-coated with a phosphate, having a median diameter of 100 μm was put into a die and was compacted using a concave three-stepped press punch at a contact pressure of 8 ton/cm² to 9 ton/cm² at a throughput of 600 pieces per hour, whereby 10,000 dust cores with a shape shown in FIG. 2(a) were prepared. The dust cores had a green density of 7.35 g/cm³ to 7.45 g/cm³.

Each obtained dust core was heat-treated at 450° C. for 30 minutes in an air atmosphere.

Subsequently, a surface (in FIG. 2(a), the upper surface) of the dust core that had a recess was ground using a grinding wheel with a shape shown in FIGS. 5(a) and 5(b) under conditions below.

Grinding Conditions

Outside diameter of grinding wheel: φ305 mm

Abrasive grains of grinding wheel: cBN

Average size of abrasive grains: 53 μm

Peripheral speed of grinding wheel: 2,000 m/min

Abrasive grains of grindstone dresser: white alumina

Average particle size of grindstone dresser: 62 μm

Slit width of grindstone: 0.5% of effective outermost circumference

Rotational speed of dust core: 550 rpm

Grinding method: die end surface surface-grinding (refer to FIG. 7(a))

Grinding time: two seconds

Grinding solution: water-soluble grinding solution containing 1% by mass of diethanolamine

FIG. 12 illustrates a ground surface of the prepared dust core.

The obtained dust cores were measured for machining accuracy. The average error of length accuracy was 1.0 μm and the dimensional variation was 5.0 μm. The flatness was 1.1 μm and the dimensional variation was 0.3 μm.

Subsequently, the dust cores were deburred using a brush prepared from a synthetic resin, such as nylon, combined with hard abrasive grains made of green silicon carbide (Step S4), was degaussed by applying an alternating-current magnetic field thereto (Step S5), and was then washed with a washing liquid containing a grinding solution used during grinding at a discharge pressure of 0.05 MPa (Step S6).

The obtained dust cores had a remanence of 5 mT or less and did not rust without, for example, specific rust-proofing such as oiling after the dust cores were left for one year in an air atmosphere, because a rust-proof component contained in the washing liquid remained on the surface of each dust core.

Furthermore, 30 of the dust cores were measured for magnetic attractive force at random, resulting in 3.1 V to 4.0 V, which satisfied properties.

### Examples 6 to 12

Dust cores were prepared under conditions shown in Tables 2 and 3 below and were then checked for magnetic attractive force and a rust-proof effect after being left for one year in an air atmosphere.

TABLE 2

| Items | | Example 6 | Example 7 | Example 8 | Example 9 | Example 10 | Example 11 | Example 12 | Example 13 |
|---|---|---|---|---|---|---|---|---|---|
| Raw | Material | Fe | Fe—Si | Fe—Ni | Fe | Fe—Si—B | Fe—Co | Fe | Fe |
| materials | Particle size | 60 | 90 | 70 | 80 | 60 | 70 | 200 | 100 |
| | Material of | Zinc | Silicon | Titanium | Magnesium | Aluminium | Iron | Manganese | Iron |
| | insulating film | phosphate | oxide | oxide | oxide | oxide | phosphate | phosphate | phosphate |
| | Thickness of | 10 | 30 | 25 | 30 | 100 | 30 | 35 | 50 |
| | insulating film (μm) | | | | | | | | |
| Compacting | Contact pressure | 13 | 10 | 11 | 12 | 12 | 11 | 13 | 13 |
| | Shape of die | Concave | Concave | Concave | Concave | Concave | Concave | Concave | Concave |
| | | multi- | multi- | multi- | multi- | multi- | multi- | multi- | multi- |
| | | stepped | stepped | stepped | stepped | stepped | stepped | stepped | stepped |
| | Temperature of | Not heated | Not heated | 80° C. | Not heated | 100° C. | Not heated | Not heated | 150° C. |
| | powder | | | | | | | | |
| | Temperature of die | 50° C. | Not heated | 80° C. | 80° C. | 100° C. | Not heated | 50° C. | 150° C. |
| | Green density | 7 | 7 | 7.5 | 7.45 | 7.1 | 7.1 | 7.2 | 7.6 |
| | Throughput | 900 pieces/ | 300 pieces/ | 600 pieces/ | 600 pieces/ | 600 pieces/ | 600 pieces/ | 600 pieces/ | 300 pieces/ |
| | | hr | hr | hr | hr | hr | hr | hr | hr |
| Heat | Temperature | 500 | 600 | 580 | 400 | 500 | 500 | 550 | 300 |
| treatment | Holding time | 20 | 60 | 30 | 60 | 20 | 20 | 10 | 20 |
| | (minutes) | | | | | | | | |
| | Atmosphere | Air | Nitrogen | Nitrogen | Air | Nitrogen | Nitrogen | Nitrogen | Air |
| Machining | Grinding method | FIG. 5(a) | FIG. 5(a) | FIG. 5(a) | FIG. 5(a) | FIG. 5(a) | FIG. 5(b) | FIG. 5(b) | FIG. 5(a) |
| conditions | Number of | 150 | 450 | 450 | 1500 | 300 | 600 | 250 | 150 |
| | revolutions of | | | | | | | | |
| | workpiece | | | | | | | | |
| | Machining time | 7 | 2 | 3 | 5 | 5 | 8 | 10 | 3 |
| | (seconds) | | | | | | | | |
| | Grinding solution | Diethanol- | Diethanol- | Diethanol- | Diethanol- | Diethanol- | Triethanol- | Triethanol- | Diethanol- |
| | | amine | amine | amine | amine | amine | amine | amine | amine |
| | Concentration of | 1.00% | 1.00% | 1.00% | 1.50% | 0.30% | 1.50% | 1.50% | 1.00% |
| | grinding solution | | | | | | | | |

TABLE 3

| Items | | Example 6 | Example 7 | Example 8 | Example 9 |
|---|---|---|---|---|---|
| Grindstone | Outside | φ305 | φ80 | φ80 | φ80 |
| | diameter | | | | |
| | Type of | Diamond | cBN | cBN | cBN |
| | abrasive | | | | |
| | Size of | 25 | 44 | 53 | 62 |
| | abrasive | | | | |
| | Peripheral | 1800 | 2000 | 2500 | 720 |
| | speed | | | | |
| | Width of slit | 0.05% | 0.30% | 1.00% | 0.75% |
| | Dressing | 450 pieces | 150 pieces | 500 pieces | 150 pieces |
| | interval | | | | |
| Dresser | Type of | Alumina | Alumina | Alumina | Alumina |
| | abrasive | | | | |
| | Size of | 18 | 53 | 62 | 74 |
| | abrasive | | | | |
| Deburring | Type | Brush | Brush | Brush | Brush |
| | Hard abrasive | GC | GC | GC | GC |
| | grains | | | | |
| | Synthetic | Nylon | Nylon | Polyvinyl chloride | Polyamide |
| | resin | | | | |
| Degaussing | Type | Alternating-current | Alternating-current | Alternating-current | Alternating-current |
| | | magnetic field | magnetic field | magnetic field | magnetic field |
| Washing | Type | Grinding solution | Grinding solution | Grinding solution | Grinding solution |
| | Pressure | 0.4 MPa | 0.2 MPa | 0.25 MPa | 0.1 MPa |
| Evaluation | Magnetic | 3.6 V | 3.1 V | 3.0 V | 3.3 V |
| results | attractive | | | | |
| | force | | | | |
| | Rust | No rust | No rust | No rust | No rust |
| | prevention | | | | |
| | performance | | | | |
| | Dimensional | <3.4 μm | <2.1 μm | <35 μm | <10 μm |
| | accuracy | | | | |
| Judge of evaluation results | | Good | Good | Good | Good |
| Items | | Example 10 | Example 11 | Example 12 | Example 13 |
| Grindstone | Outside | φ305 | φ60 | φ60 | φ305 |
| | diameter | | | | |
| | Type of | Diamond and fine | Diamond | cBN and fine cBN | cBN |
| | abrasive | diamond particles | | particles | |
| | Size of | 88 | 74 | 30 | 62 |
| | abrasive | | | | |
| | Peripheral | 1500 | 1000 | 3000 | 1600 |
| | speed | | | | |
| | Width of slit | 0.90% | 0.50% | 0.30% | 0.75% |
| | Dressing | 600 pieces | 900 pieces | 1500 pieces | 150 pieces |
| | interval | | | | |
| Dresser | Type of | Silicon carbide | Diamond | cBN | Alumina |
| | abrasive | | | | |
| | Size of | 105 | 74 | 30 | 53 |
| | abrasive | | | | |
| Deburring | Type | Brush | Brush | Brush | Brush |
| | Hard abrasive | GC | WA | WA | GC |
| | grains | | | | |
| | Synthetic | Polycarbonate | Polyacetal | Polyethylene | Nylon |
| | resin | | | | |
| Degaussing | Type | Alternating-current | Alternating-current | Alternating-current | Alternating-current |
| | | magnetic field | magnetic field | magnetic field | magnetic field |
| Washing | Type | Grinding solution | Grinding solution | Grinding solution | Grinding solution |
| | Pressure | 0.3 MPa | 0.05 MPa | 0.1 MPa | 0.1 MPa |
| Evaluation | Magnetic | 3.0 V | 4.1 V | 3.5 V | 3.0 V |
| results | attractive | | | | |
| | force | | | | |
| | Rust | No rust | No rust | No rust | No rust |
| | prevention | | | | |
| | performance | | | | |
| | Dimensional | <44 μm | <2.1 μm | <8.6 μm | <2.9 μm |
| | accuracy | | | | |

| | | | | |
|---|---|---|---|---|
| Judge of evaluation results | Good | Good | Good | Good |

A dust core obtained by a manufacturing method according to the present invention can be formed into a coil component by coiling, for example, a copper wire around the dust core. In this case, an insulating insulator may be used for coiling.

### REFERENCE SIGNS LIST

1 Dust core
2 Through-hole
3 Recess
10 Grinding wheel
11 Recess
12 Periphery
13 Grindstone portion
13a Grinding surface
14 Grooved portions

1-17. (canceled)

18. A method for manufacturing a dust core, comprising:
a step of compacting an insulation-coated pure iron powder or an iron-based alloy powder mainly containing iron using a die to obtain the dust core;
a step of heat-treating the obtained dust core; and
a step of post-machining at least one portion of the heat-treated dust core using a grinding wheel,
wherein the post-machining step is a step of performing grinding in such a manner that the dust core and the grinding wheel are rotated.

19. The manufacturing method according to claim 18, wherein the die includes a first die and second die facing each other, at least one of the first die and the second die exhibits a stepped shape having a convex portion and/or a concave portion or a shape that a plurality of stepped portions are separated, and the dust core obtained by compacting has a density of 7.0 g/cm³ to 7.6 g/cm³.

20. The manufacturing method according to claim 18, wherein the rotational speed of the dust core ranges from 150 rpm to 1,500 rpm and the grinding wheel is rotated at a peripheral speed of 720 m/min or more and not more than the maximum allowable peripheral speed thereof.

21. The manufacturing method according to claim 18, wherein the grinding wheel contains abrasive grains which have a median diameter of 25 μm to 88 μm and which are made of diamond or cubic boron nitride.

22. The manufacturing method according to claim 18, wherein the grinding wheel has a grinding surface which contributes to machining and which has at least one grooved portion extending to the outer edge of the grinding wheel and the width of the grooved portion ranges from 0.05% to 1.00% of the effective outermost circumference of the grinding wheel.

23. The manufacturing method according to claim 18, further comprising a step of dressing the grinding wheel, wherein a major component of a dresser used for dressing is at least one selected from the group consisting of white alumina, green silicon carbide, diamond, and cubic boron nitride and the dresser has a median diameter of 18 μm to 105 μm.

24. The manufacturing method according to claim 18, wherein in the post-machining step, a water-soluble grinding solution containing 0.3% to 1.5% by mass of at least one of diethanolamine and triethanolamine is used.

25. The manufacturing method according to claim 18, wherein the pure iron powder or the iron-based alloy powder mainly containing iron has a median diameter of 60 μm to 250 μm.

26. The manufacturing method according to claim 18, wherein the pure iron powder or the iron-based alloy powder mainly containing iron is compacted at a contact pressure of 6 ton/cm² to 13 ton/cm².

27. The manufacturing method according to claim 18, wherein in the heat-treating step, the dust core is heat-treated at a temperature of 300° C. to 600° C. for at least ten minutes in air, a nitrogen atmosphere, or a flow of a mixture thereof.

28. The manufacturing method according to claim 18, further comprising a step of removing burrs formed on the surface of the dust core during compacting or post-machining, wherein the burrs are removed using a brush prepared from a synthetic resin combined with hard abrasive grains made of white alumina or green silicon carbide.

29. The manufacturing method according to claim 18, further comprising a step of performing degaussing subsequently to the removal of the burrs such that the remanence is 5 mT or less.

30. The manufacturing method according to claim 29, further comprising a step of washing the dust core with a washing liquid containing the water-soluble grinding solution used during post-machining at a discharge pressure of 0.05 MPa to 0.40 MPa subsequently to degaussing.

31. A dust core formed by compacting an insulation-coated pure iron powder or an iron-based alloy powder mainly containing iron using a die, having a machined surface having isotropic machining marks formed on at least one portion thereof by a grinding wheel, the dust core exhibiting a stepped shape having a convex portion or a concave portion or a shape that a plurality of stepped portions are separated, the dust core having a density of 7.0 g/cm³ to 7.6 g/cm³.

32. The dust core according to claim 31, wherein the dimensional accuracy of the flatness and parallelism of the machined surface is 50 μm or less in terms of machining error.

33. The dust core according to claim 31, comprising at least one portion coated with a rust-proof layer containing at least one of diethanolamine and triethanolamine which is a component of a water-soluble grinding solution used during machining due to a grinding wheel.

34. A coil component prepared by coiling a copper wire around a dust core manufactured by a manufacturing method according to claim 18.
